(19) United States
(12) Patent Application Publication
(10) Pub. No.: US 2004/0052523 A1
(43) Pub. Date: Mar. 18, 2004

(54) SYSTEM AND METHOD FOR MEASURING IN-BAND CROSS-TALK IN OPTICAL COMMUNICATION SYSTEMS

(76) Inventors: Michael John Yadlowsky, Corning, NY (US); Mark Francis Krol, Painted Post, NY (US); J. Michael Harris, Elmira, NY (US)

Correspondence Address: JONES VOLENTINE, L.L.C., SUITE 150, 12200 SUNRISE VALLEY DRIVE, RESTON, VA, 20191, US

(21) Appl. No.: 09/758,219

(22) Filed: Jan. 12, 2001

(51) Int. Cl. H04B 10/08; H04B 10/18; H04J 14/02

(52) U.S. Cl. 398/34; 398/27; 398/81

(57) ABSTRACT

A method of and system for estimating the bit error rate of a channel in an optical communication system includes a method of and system for measuring the in-band cross-talk of the channel in a wavelength division multiplexed system. A single channel is selected from the plurality of channels in the optical communication system. The signal in this single channel is passed to a digital signal processor proportional to the time rate of change of a phase of an optical source generating the signal. The digital signal processor converts the filtered signal into the frequency domain, and a spectrum analyzer determines the features of the in-band cross-talk from the signal in the frequency domain. The features of the in-band cross-talk may be combined with other measured noise features, such as the power spectral density, to estimate BER.

### CROSS REFERENCE TO RELATED APPLICATIONS

The present invention is related to and claims priority from U.S. Provisional Patent Application No. 60/176,054, filed Jan. 14, 2000. The disclosure of this application is specifically incorporated by reference herein.

### FIELD OF THE INVENTION

The present invention is directed to a system and method for measuring in-band cross-talk in an optical communication system, and particularly for using such measurement in conjunction with other measurements to estimate bit error rate (BER).

### BACKGROUND OF THE INVENTION

Optical routing in optical communication systems, such as wavelength-division-multiplexed (WDM) optical systems, requires a wavelength and polarization insensitive optical switch. Determining a bit error rate (BER) after each of these switches is useful for determining and maintaining the health of a WDM network. The BER is defined as the ratio of the number of erroneous bits received to the total number of bits received per second.

One way of characterizing the performance of a transmission system is to measure the BER level to form eye diagrams. Eye diagrams are a known technique to track channel power as a function of time. These diagrams are generated by plotting the received signal as a function of time, and then shifting the time axis by one bit interval and plotting again. The superimposed bits define most probable (constructive and destructive) interference events due to transmission in the channels adjoining the particular channel plotted. Thereby, the eye diagram depicts the worst-case impairment as measured by the greatest ordinate value clear of traces (by the vertical dimension of the clear space between a peak and a null). A system that is not excessively impaired shows clear discrimination between “1's” and “0's” in a digital signal, with an “eye opening” in the center of the diagram. A truly unimpaired system is considered to have an eye opening of 1.0.

Generally, the impairments that limit the system's performance cause two types of degradation in the received eye pattern; random fluctuations in the bit energy (caused by noise) and non-random pulse shape distortions. Non-random pulse shape distortions are sometimes referred to as Inter-Symbol Interference (ISI). As bit rates increase to the gigabit per second range and higher it becomes useful to manage the impairments that affect the shape of the received pulses, and to limit the ISI. While compensation of ISI has met with some success, compensation of random fluctuations remains difficult. Ultimately, these random fluctuations may significantly impact the BER of the optical system.

Ideally, the BER of each channel would be measured independently of the type of modulation present. This is typically done in the laboratory by sending a pseudo-random bit stream through the system and comparing data at both ends of the system. However, since the desired systems have a very low BER, it may be difficult to directly measure the BER practically. Further, the processes affecting the BER could vary significantly over the extended period of time required to measure the BER. Thus, if the BER increased significantly above the desired BER even for a relatively short period of time, the mean BER would most likely be below a desired threshold BER, making this measurement unreliable. Moreover, when attempting to assess the BER of deployed systems, direct measurement is even more impractical. As such, techniques have been developed to estimate the BER using parameters such as the optical signal-to-noise ratio (OSNR) as well as other electrical noise sources.

Typically, monitoring the BER of a system is conducted using spectrum analyzers to look at the primary noise source, such as amplified spontaneous emission (ASE). However, sources of noise other than ASE may be present which are not apparent from the optical signal-to-noise ratio (OSNR), but which still affect the BER. Efforts to find a metric of BER typically entail demodulating the transmitted signal, measuring the power spectral density (i.e., carrier signal power to noise floor), or channel sampling. While the accuracy of this inferential technique may increase with each additional accurate assessment of noise parameters, there is still a need to improve techniques for estimating the BER.

### SUMMARY OF THE INVENTION

The present invention is directed to measuring an additional metric of BER, which may be used to enhance the estimation of BER.

It is an object of the present invention to provide determination of features of in-band cross-talk in an optical communication system and use this as a metric in estimating the BER.

According to an exemplary embodiment of the present invention, a system for estimating in-band cross-talk in an optical communication system may include a selective element for separating a signal in a desired channel from a plurality of channels in the optical communication system; a filter, which passes the signal at a rate proportional to the time rate of change of a phase of an optical source generating the signal; a digital signal processor, which receives the signal from the filter and converts the signal into a frequency domain; and a spectrum analyzer, which measures at least one feature of the signal in the frequency domain to quantify the in-band cross-talk.

According to another exemplary embodiment of the invention, a method for estimating in-band cross-talk in an optical communication system includes separating a signal in a desired channel from a plurality of channels in the optical communication system; passing the signal in proportion to the time rate of change of a phase of an optical source generating the signal; converting the signal into a frequency domain; and analyzing at least one feature of the signal in the frequency domain to quantify the in-band cross-talk.

It is further an object of the present invention to provide a more accurate estimate of BER in optical communication systems which are sensitive to in-band cross-talk, for example in systems employing wavelength division multiplexing, independently of transmitted data format.

According to another exemplary embodiment of the invention, estimating bit error rate (BER) in an optical communication system includes a selective element, which separates a signal in a desired channel from a plurality of channels in the optical communication system; a filter, which passes the signal at a rate proportional to the time rate of change of a phase of an optical source generating the signal; a digital signal processor, which converts the signal into a frequency domain; a spectrum analyzer which measures at least one feature of the signal in the frequency domain to quantify the in-band cross-talk; and a post processor which combines at least one feature measured by the spectrum analyzer with at least one noise feature to estimate BER.

According to another exemplary embodiment of the present invention, a method for estimating bit error rate (BER) in an optical communication system includes separating a signal in a desired channel from a plurality of channels in the optical communication system; passing the signal at a rate proportional to the time rate of change of a phase of an optical source generating the signal; converting the signal into a frequency domain; analyzing the signal in the frequency domain to quantify the in-band cross-talk; and combining at least one feature from the analyzing with at least one noise feature to estimate BER.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a block diagram of the system for measuring in-band cross-talk in accordance with an exemplary embodiment of the present invention.

FIGS. 2a-2h are plots of gain versus frequency for varying levels of power in the low frequency spectrum measured according to an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art that the present invention may be practiced in other embodiments that depart from the specific details disclosed herein. In other instances, detailed descriptions of well-known devices and methods may be omitted so as not to obscure the description of the present invention.

The amount of noise determines the BER a channel can attain. Briefly, the present invention is directed to recognizing that one metric of BER is the in-band cross-talk. In-band cross-talk is an extraneous optical field, which interferes with the communications signal upon optical-to-electrical conversion resulting in noise having a spectrum, which falls within the electrical bandwidth of the receiver system. Illustratively, in-band cross-talk may be cross-talk within a single channel, which arises from any pair of back reflections generated in an optical communication system. In an optical communication system, if a signal is reflected twice, that erroneous signal is then traveling in the same direction as the desired as the desired signal and may interfere with the desired signal. Even if the wavelength output by the optical source is stable, the time delay between the input signal and the reflected signal may interfere, and this may lead to beating. To this end, the relative phase is random and temporally varying, leading to a time varying interference (e.g., beating). The importance of measuring in-band cross-talk has increased with the rise of optical networking, in which the network may be reconfigured by the flip of a switch.

Since there may be numerous sources of noise in an optical system, it is difficult to discern which portions of the noise spectrum are due to which sources. For example, in-band cross-talk does not normally change the overall optical signal-to-noise ratio (OSNR), since the in-band cross-talk occurs in a much narrower spectrum than the OSNR and is not resolved in the OSNR measurements. However, in-band cross-talk normally will be concentrated in a spectral region in proportion to the time rate of change of the relative phases between the signal and the cross-talk components. For some devices such as semiconductor lasers, this type of noise will be most prevalent at low (e.g., radio) frequencies. By taking the ratio of the noise spectral densities within this band and outside this band, the noise due to in-band cross-talk may be determined. While the absolute value of the in-band cross-talk is difficult to ascertain, the relative values may be useful in estimating the BER, especially when used with other metrics of BER to improve these estimates. The measurement of phase noise in an optical source is known from the study of laser noise, as set forth, for example, in U.S. Pat. No. 5,199,038 entitled “Semiconductor Laser Noise Reduction.” The disclosure of this U.S. patent is specifically incorporated by reference herein.

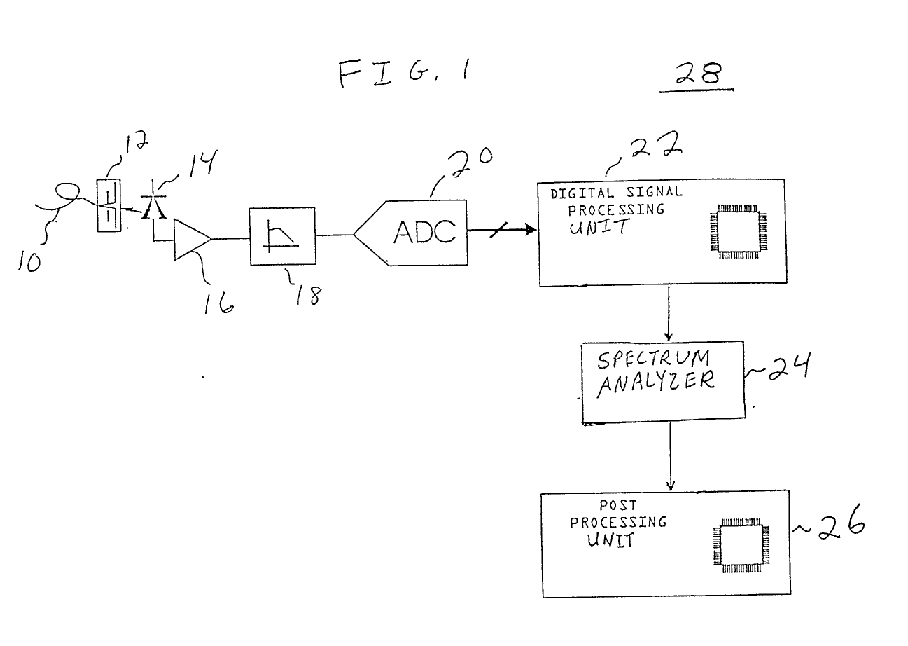

A configuration for determining the low frequency features of in-band crosstalk in a single WDM channel in an optical communication system 28 according to an exemplary embodiment of the present invention is shown in FIG. 1. All incoming WDM channels on an optical waveguide such as an optical fiber 10 are passed through a selective element 12. After passing through the selective element 12, the signals are incident on a photodetector 14. A single channel from the plurality of WDM channels is selected based on the corresponding illuminated pixel for the deflected wavelength or the location of the tunable filter.

According to the illustrative embodiment of the present invention shown ion FIG. 1, the optical communication system 28 incorporates an optical waveguide such as an optical fiber and/or a planar optical waveguide. However, the invention of the present disclosure may be used in optical communication systems incorporating other types of optical wavguides. Moreover, the invention of the present disclosure may be used in optical communication systems, which include “free-space” portions as well. These free-space portions include, but are not limited to, micro-optic devices such as filters, isolators and switches. Finally, in the exemplary embodiment shown in FIG. 1, selective element 12 may be a dispersive element, or a tunable filter. If a tunable filter is used, the filter location may be dithered to ensure optimal channel overlap with the filter passband. This dithering frequency may then be filtered out by postprocessing. The input signal is demultiplexed (and spatially separated) into component wavelengths by the selective element 12. The selective element 12 may be any conventional demultiplexer, such as a grating, a blazed grating, an arrayed waveguide grating, or a prism; a micro-optic based filter; a thin-film based filter; or a waveguide based filter such as a fiber Bragg grating (FBG). Of course, this list is illustrative and not exhaustive and other optical elements within the purview of the artisan of ordinary skill may be used for selective element 12.

The signal from the selected channel is passed from the photodetector 14 through a low-noise pre-amplifier 16 and low frequency filter 18, which is illustratively an anti-aliasing filter. The low frequency filter 18 is selected in proportion to the time rate of change of the phase in the optical source (not shown) and according to well known radio frequency (rf) techniques. The signal is then sampled by an analog-to-digital converter (ADC) 20 at a frequency high enough to prevent signal degradation due to aliasing; illustratively this frequency is equal to or greater than the Nyquist frequency (f_{N}) of the previous analog filter 18. In this embodiment, the dynamic range of these elements is illustratively greater than 30 dB.

A digital signal processing (DSP) unit 22 recovers the low frequency signature across the phase noise spectrum of the optical source (e.g. laser) spectrum by converting the signal from the ADC 20 to the frequency domain via windowing and either a Discrete Fourier Transform (DFT) or a Fast Fourier Transform (FFT). If the levels of in-band cross-talk are relatively low (illustratively on the order of −30 dB), additional signal averaging in the frequency domain with a finite impulse response (FIR) filter is usefully performed.

The resultant signal is then provided to a spectrum analyzer 24 which can be used to determine the magnitude, location, number and width of the in-band cross-talk features; particularly the peak of the spectrum, for a more accurate picture. Alternatively or simultaneously, the noise spectral density of the in-band cross-talk spectrum can be averaged over an appropriate frequency range and then compared with a spectrum outside this frequency range to estimate the contribution of the in-band cross-talk to the BER. The appropriate frequency range is determined by the speed with which the phase noise of the optical source changes. However, the lower frequencies of this range, where 1/f noise is prevalent, should not be included. An upper end should cut off well after any such noise is expected to be present. For example, the appropriate frequency range may be from about 3/4 of where the phase noise maxima occur to about twice this frequency. This value is dependent on the phase noise spectrum of the source. Illustratively, for DFB lasers, this frequency range is on the order of approximately 50 MHz.

Once these in-band cross-talk features have been quantified, these features may be combined with other measurements to provide a more accurate estimate of BER in a post processing unit (PPU) 26. Illustratively, the in-band cross-talk features may be combined with the received signal's power spectral density (PSD). The PSD is the Fourier transform of the autocorrelation of the noise amplitude, i.e., the degree to which any the noise random variables at different times depend on one another.

Additional information may be included in the PPU to increase the accuracy of the BER estimate. Such information may include but is not necessarily limited to the ASE noise floor, the number of add/drops the channel has undergone, the width of the main lobe of the PSD, and the location of the wavelength band of the channel. By converting the phase noise of in-band cross-talk into amplitude noise, the metric of the in-band cross-talk may be readily included with the other metrics to more accurately estimate BER. An example of how to convert phase noise can be found in J. Gimlett and N. Cheung, “Effect of Phase-to-Intensity Noise Conversion by Multiple Reflection on Gigabit/sec DFB Laser Transmission Systems,” Journal of Lightwave Technology, Vol. 7, pp. 888-895 (1989), the disclosure of which is specifically incorporated by reference herein.

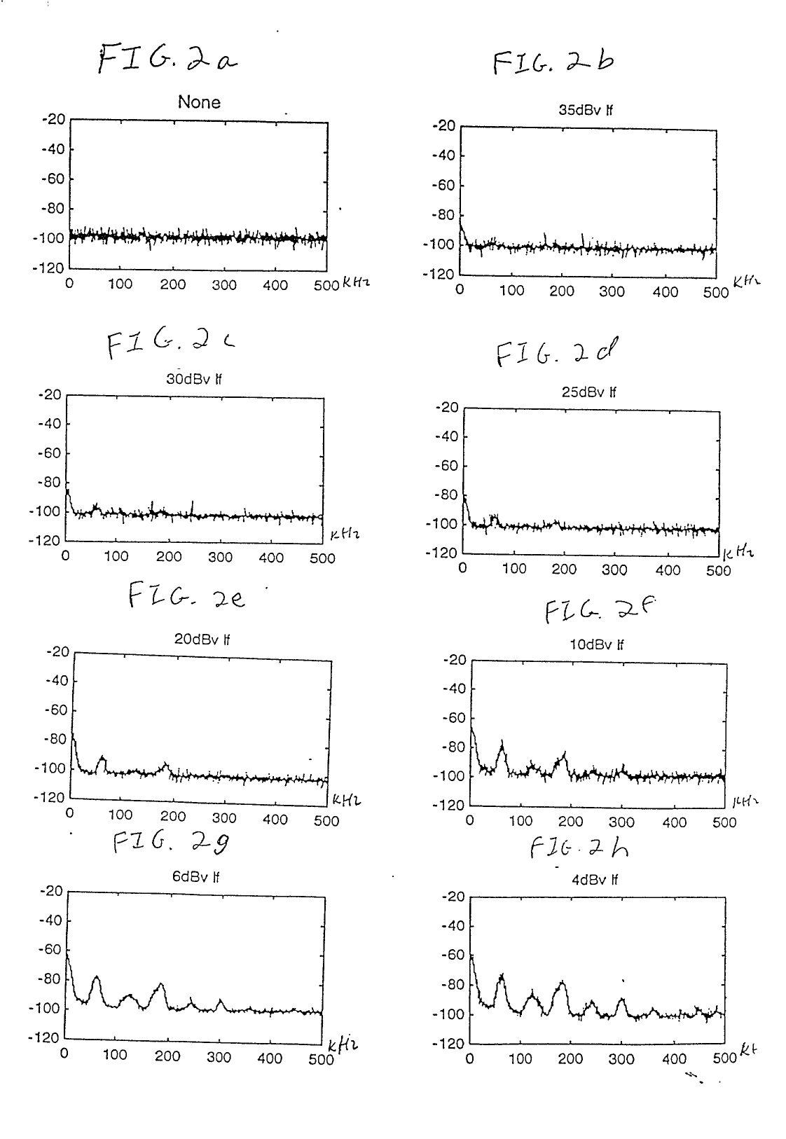

FIGS. 2a-2h illustrate the in-band cross-talk features measured by the illustrative system of FIG. 1. As can be seen therein, the in-band cross-talk features increase with increasing levels of power. For the plots shown in FIGS. 2a-2h, the data was processed with sixty-four averages to reduce the influence of other noises.

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims.

We claim:

1. A system for estimating in-band cross-talk in an optical communication system comprising:
a selective element which separates a signal in a desired channel from a plurality of channels in the optical communication system;
a filter which passes the signal in proportion to a time rate of change of a phase of an optical source generating the signal;
a digital signal processor which receives the signal from the filter and converts the signal into a frequency domain; and
a spectrum analyzer which analyzes at least one feature of the signal in the frequency domain to quantify the in-band cross-talk.

2. The system of claim 1, wherein the digital signal processor averages the signal in the frequency domain to reduce an effect of noise.

3. The system of claim 1, wherein the selective element includes a tunable filter.

4. The system of claim 1, wherein the selective element includes a dispersive device.

5. The system of claim 1, wherein the selective element is chosen from the group consisting of: gratings, thin film based filters, micro-optic based filters, and waveguide based filters.

6. The system of claim 1, wherein the at least one feature is a magnitude of a peak of a spectrum.

7. The system of claim 1, wherein the at least one feature is a location of a peak of a spectrum.

8. The system of claim 1, wherein the at least one feature is a number of peaks of a spectrum.

9. The system of claim 1, wherein the at least one feature is a width of a peak of a spectrum.

10. The system of claim 1, wherein the at least one feature is a feature of in-band cross-talk.

11. The system of claim 1, wherein the at least one feature is a noise spectral density of a spectrum of the in-band cross-talk, averaged over a frequency range.

12. The system of claim 11, wherein the frequency range is from approximately 0.75 to approximately 2.0 times a frequency of a phase noise maximum.

13. The system of claim 11, wherein the frequency range is approximately 50 MHz.

14. A system for estimating bit error rate (BER) in an optical communication system comprising:
a selective element which separates a signal in a desired channel from a plurality of channels in the optical communication system;
a filter which passes a signal in proportion to a time rate of change of a phase of an optical source generating the signal;
a digital signal processor which receives the signal from the filter and converts the signal into a frequency domain;
a spectrum analyzer which measures at least one feature of the signal in a frequency domain to quantify in-band cross-talk; and
a post processor which combines the at least one feature measured by the spectrum analyzer with at least one noise feature to estimate BER.

15. The system of claim 14, wherein the digital signal processor averages the signal in the frequency domain to reduce an effect of noise.

16. The system of claim 14, wherein the selective element includes a tunable filter.

17. The system of claim 14, wherein the selective element includes a dispersive device.

18. The system of claim 14, wherein the selective element is chosen from the group consisting of: gratings, thin film based filters, micro-optic based filters, and waveguide based filters.

19. A system of in claim 14, wherein the at least one feature is chosen from the group consisting of: a magnitude, a location, and a width of a peak of a spectrum.

20. A system as recited in claim 14, wherein the at least one noise feature is a received signal power spectral density.

21. The system of claim 14, wherein the at least one feature is a noise spectral density of a spectrum of the in-band cross-talk, averaged over a frequency range.

22. The system of claim 21, wherein the frequency range is from approximately 0.75 to approximately 2.0 times a frequency of a phase noise maximum.

23. The system of claim 21, wherein the frequency range is approximately 50 MHz.

24. A method for estimating in-band cross-talk in an optical communication system, the method comprising:
separating a signal in a desired channel from a plurality of channels in the optical communication system;
passing the signal in proportion to a time rate of change of a phase of an optical source generating the signal;
converting the signal into a frequency domain; and
analyzing at least one feature of the signal in the frequency domain to quantify in-band cross-talk.

25. The method of claim 24, further comprising, after the converting, averaging a noise spectral density of an in-band cross-talk spectrum and comparing the averaged noise spectral density with a spectrum to estimate a contribution of the in-band cross-talk to a bit-error rate.

26. The method of claim 24, wherein the at least one feature is a magnitude of a peak of a spectrum.

27. The method of claim 24, wherein the at least one feature is a location of a peak of a spectrum.

28. The method of claim 24, wherein the at least one feature is a number of peaks of a spectrum.

29. The method of claim 24, wherein the at least one feature is a width of a peak of a spectrum.

30. The method of claim 24, wherein the at least one feature is a feature of in-band cross-talk.

31. The method of claim 30, wherein the method further comprises, after the converting, averaging a noise spectral density of a spectrum of the in-band cross-talk over a frequency range and comparing the averaged noise spectral density of the spectrum with a spectrum outside the frequency range to estimate the contribution of the in-band cross-talk to a bit error rate.

32. The method of claim 31, wherein the frequency range is from approximately 0.75 to approximately 2.0 times a frequency of a phase noise maximum.

33. The method of claim 32, wherein the frequency range is approximately 50 MHz.

34. A method for estimating bit error rate (BER) in an optical communication system, the method comprising:
separating a signal in a desired channel from a plurality of channels in the optical communication system;
passing the signal in proportion to a time rate of change of a phase of an optical source generating the signal;
converting the signal into a frequency domain;
analyzing the signal in the frequency domain to quantify in-band crosstalk; and
combining at least one feature from the analyzing with at least one noise feature to estimate the bit error rate.

35. The method of claim 34, wherein the at least one feature is chosen from a group consisting of: a magnitude, a location and a width of a peak of a spectrum.

36. The method of claim 34, wherein the at least one noise feature is a received signal power spectral density.

37. The method of claim 34, further comprising, after the converting, averaging a noise spectral density of an in-band cross-talk spectrum with a spectrum to estimate a contribution of the in-band cross-talk to the bit-error rate.

38. The method of claim 34, wherein the method further comprises, after the converting, averaging a noise spectral density of a spectrum of the in-band cross-talk over a frequency range and comparing the averaged noise spectral density of the spectrum with a spectrum outside the frequency range to estimate the contribution of the in-band cross-talk to the bit error rate.

39. The method of claim 38, wherein the frequency range is from approximately 0.75 to approximately 2.0 times a frequency of a phase noise maximum.

40. The method of claim 38, wherein the frequency range is approximately 50 MHz.
